(19) United States
(12) Patent Application Publication
(10) Pub. No.: US 2008/0301632 A1
(43) Pub. Date: Dec. 4, 2008

(54) Controller programmed with graphical language driving molecular sensor

(75) Inventors: John Lawrence Ervin, San Diego, CA (US); Hus Tigli, La Jolla, CA (US)

Correspondence Address: TREX ENTERPRISES CORP., 10455 PACIFIC COURT, SAN DIEGO, CA, 92121, US

(73) Assignee: Trex Enterprises Corp.

(21) Appl. No.: 12/221,128

(22) Filed: Jul. 30, 2008

Related U.S. Application Data
(63) Continuation-in-part of application No. 11/180,349, filed on Jul. 13, 2005.
Application No. 11/180,349 is a continuation-in-part of application No. 10/631,592, filed on Jul. 30, 2003.
Application No. 10/631,592 is a continuation-in-part of application No. 10/616,251, filed on Jul. 8, 2003.
(60) Provisional application No. 60/962,652, filed on Jul. 30, 2007.
(60) Provisional application No. 60/962,616, filed on Jul. 30, 2007.
(60) Provisional application No. 60/962,664, filed on Jul. 30, 2007.
(60) Provisional application No. 60/962,756, filed on Jul. 30, 2007.
(60) Provisional application No. 60/962,675, filed on Jul. 30, 2007.
(60) Provisional application No. 60/962,669, filed on Jul. 30, 2007.
(60) Provisional application No. 60/962,644, filed on Jul. 30, 2007.
(60) Provisional application No. 61/127,910, filed on May 15, 2008.

(51) Int. Cl. G06F 9/44

(52) U.S. Cl. 717/114

(57) ABSTRACT

An easy way of introducing a controller into an instrument used to study biomolecular interactions without labels. By introducing a controller, which may be programmed using a graphical programming language, into the system the development time for that system can be made much shorter.

### CROSS-REFERENCE TO RELATED APPLICATIONS

This application claims the benefit of provisional patent applications Ser. Nos. 60/962,652, 60/962,616, 60/962,664, 60/962,756, 60/962,675, 60/962,669 and 60/962,644 all filed Sep. 30, 2007 and provisional patent application Ser. No. 61/127,910, filed May 15, 2008 and is a continuation in part of Ser. No. 11/180,349 filed Jul. 13, 2005, Ser. No. 10/631,592 filed Jul. 30, 2003 and Ser. No. 10/616,251 filed Jul. 8, 2003.

### FIELD OF INVENTION

This invention relates to control systems and in particular to computer control systems programmed to control optical sensors such as optical biosensors.

### BACKGROUND OF THE INVENTION

### Optical Biosensors

An optical biosensor is an optical sensor that incorporates a biological sensing element. In recent years optical biosensors have become widely used for sensitive molecular binding measurements. To study interactions of proteins with other biomolecules one may generally use labeled or label-free methods. For these methods a first molecule of interest (the receptor) is immobilized onto a surface. An interaction is monitored by then introducing additional molecules (the targets) and detecting whether they in fact bind to the receptor. When using labels to monitor these interactions a fluorescent, colorimetric or some other signal is generated by an additional molecule or moiety that is attached to the target or receptor which gives a signal when the interaction takes place. This so called label (or tag) is present only to detect the interaction and is not part of the interaction of interest per se.

In label free binding, on the other hand, the receptor and target binding are monitored directly using untagged biomolecules. A variety of technologies exist in the art to detect binding without labels including surface plasmon resonance (SPR) and white light interferometery using porous silicon. In addition to the variety of technologies which exist to monitor label free binding events, there are a variety of instrument architectures which can used. These include plate readers and flow cells. In the case of plate readers a well plate (or micro well plate or micro titer plate) is used to house the biochips and fluids which are used for the label free binding studies. This allows for parallel analyses of several types of data. Alternatively flow cells house biochips in, typically, a microfluidic cell which routes fluid over the region of the biochip where the binding interaction takes place.

When acquiring and analyzing data of this sort there are a number of steps which are performed for the data analysis (the data method) on a number of channels (be those channels, flow cells or wells in a well plate). A file format which captures the full gamut of what a user of the analytical instrument might want to do must incorporate flexibility in acquisition and in analysis.

### Surface Plasmon Resonance

An optical biosensor technique that has gained increasing importance over the last decade is the surface plasmon resonance (SPR) technique. This technique involves the measurement of light reflected into a narrow range of angles from a front side of a very thin metal film producing changes in an evanescent wave that penetrates the metal film. Ligands and analytes are located in the region of the evanescent wave on the backside of the metal film. Binding and disassociation actions between the ligands and analytes can be measured by monitoring the reflected light in real time. These SPR sensors are typically very expensive. As a result, the technique is impractical for many applications.

### Resonant Mirror

Another optical biosensor is known as a resonant mirror system, also relies on changes in a penetrating evanescent wave. This system is similar to SPR and, like it, binding reactions between receptors and analytes in a region extremely close to the back side of a special mirror (referred to as a resonant mirror) can be analyzed by examining light reflected when a laser beam directed at the mirror is repeatedly swept through an arc of specific angles. Like SPR sensors, resonant mirror systems are expensive and impractical for many applications.

### Thin Films

It is well known that monochromic light from a point source reflected from both surfaces of a film only a few wavelengths thick produces interference fringes and that white light reflected from a point source produces spectral patterns that depend on the direction of the incident light and the index of refraction of film material. (See “Optics” by Eugene Hecht and Alfred Zajac, pg. 295-309, Addison-Wesley, 1979.)

### Porous Silicon Layers

U.S. Pat. No. 6,248,539 (incorporated herein by reference) discloses techniques for making porous silicon and an optical resonance technique that utilizes a very thin porous silicon layer within which binding reactions between ligands and analytes take place. The association and disassociation of molecular interactions affects the index of refraction within the thin porous silicon layer. Light reflected from the thin film produces interference patterns that can be monitored with a CCD detector array. The extent of binding can be determined from change in the spectral pattern.

### Kinetic Binding Measurements

Kinetic binding measurements involve the measurement of rates of association (molecular binding) and disassociation. Analyte molecules are introduced to ligand molecules producing binding and disassociation interactions between the analyte molecules and the ligand molecules. Association occurs at a characteristic rate [A] [B]kₒₙ that depends on the strength of the binding interaction kₒₙ and the ligand topologies, as well as the concentrations [A] and [B] of the analyte molecules A and ligand molecules B, respectively. Binding events are usually followed by a disassociation event, occurring at a characteristic rate [A][B]k_{off} that also depends on the strength of the binding interaction. Measurements of rate constants kₒₙ and k_{off} for specific molecular interactions are important for understanding detailed structures and functions of protein molecules. In addition to the optical biosensors discussed above, scientists perform kinetic binding measurements using other separations methods on solid surfaces combined with expensive detection methods (such as capillary liquid chromatography/mass spectrometry) or solution-phase assays. These methods suffer from disadvantages of cost, the need for expertise, imprecision and other factors.

### Separations-Based Measurements

More recently, optical biosensors have been used as an alternative to conventional separations-based instrumentation and other methods. Most separations-based techniques have typically included 1) liquid chromatography, flow-through techniques involving immobilization of capture molecules on packed beads that allow for the separation of target molecules from a solution and subsequent elution under different chemical or other conditions to enable detection; 2) electrophoresis, a separations technique in which molecules are detected based on their charge-to-mass ratio; and 3) immunoassays, separations based on the immune response of antigens to antibodies. These separations methods involve a variety of detection techniques, including ultraviolet absorbance, fluorescence and even mass spectrometry. The format also lends itself to measure of concentration and for non-quantitative on/off detection assays.

What is needed is a control system for driving molecular sensors.

### SUMMARY OF THE INVENTION

The present invention provides an easy way of introducing a controller into an instrument used to study biomolecular interactions without labels. By introducing a controller, which may be programmed using a graphical programming language, into the system the development time for that system can be made much shorter. Additionally that controller may be embedded in a chassis that can be configured with multiple IO modules which are commonly used for this application. Finally, how these reconfigurable modules may be cross connected to the other subsystems of the instrument are described.

### BRIEF DESCRIPTION OF THE DRAWINGS

FIG. 1 Configuration of the compactRIO chassis for the label free binding instrument

FIG. 2 Interface board that connects the compactRIO system to subsystems of instrument

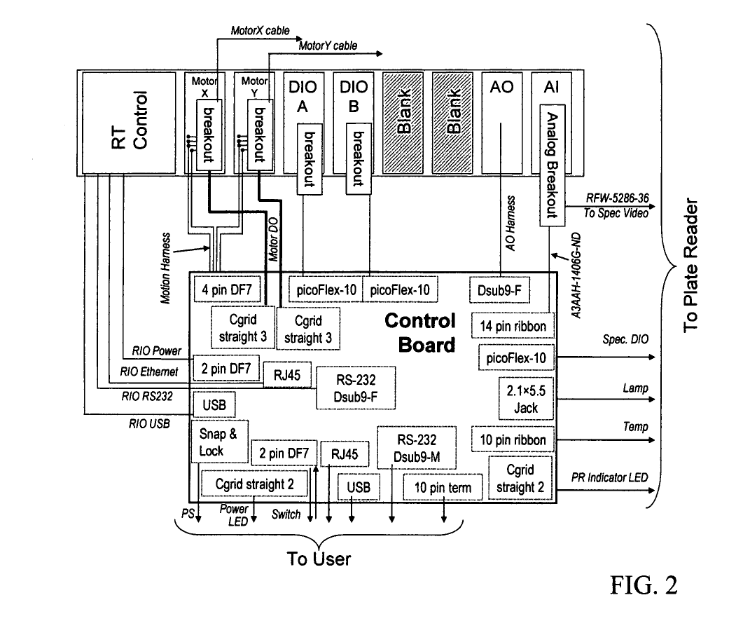

### DETAILED DESCRIPTION OF PREFERRED EMBODIMENTS

A preferred embodiment of the present invention is an embedded microprocessor based controller that is programmable in a graphical language for controlling an analytical instrument used for label free binding studies on biological molecules.

When designing an instrumentation system, the components which are redundant for the flow cell and plate reader are kept in a separate module. This allows for not only an economy in the number of parts but also for an easy path to add modules—as the control module in this design has the capacity to drive a flow cell, a plate reader, or both. In all cases the subsystems in these modules are under microprocessor control. This microprocessor also handles communication between the instrument and control software.

Various methods of programming embedded controllers are known in the art including but not limited to low level assembly language, the higher level C language, and the object oriented C++ language. In this preferred embodiment a graphical language LabView is used for a label free binding instrument. LabView—a language developed by National Instruments—speeds both the development process as well as the code maintenance process for analytical instrument firmware development.

Finally the fact that the controller is a chassis—rather than a printed circuit board—allows for easy reconfiguration. Should additional functionality be required by the users of the instrument, additional modules may be added to the chassis to accommodate this.

The example presented here makes use of a compactRIO controller (National Instruments, Austin, Tex.). This reconfigurable controller contains a Pentium class processor together with Ethernet, RS232 and USB communication links. The processor is housed in a unit which connects to a 4 or 8 slot chassis. This chassis contains a field programmable gate array which is programmable in the graphical language LabView.

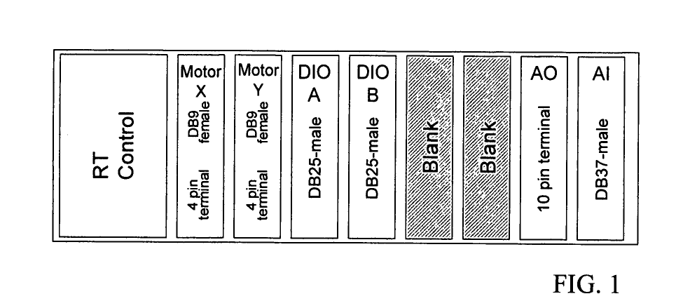

FIG. 1 shows the configuration of the compactRIO chassis for use with a plate reader label-free binding instrument. Here the graphically programmed chassis contains modules for motion control, digital input and digital output (DIO) and analog output (AO) and input (AI). To make use of this chassis in an embedded instrument for label free binding, however requires that the several logical functions of the compactRIO be programmed and routed to the various subsystems of the instrument. The control board in FIG. 1 is designed for that purpose.

Here the several compactRIO functions are brought to a control board. This control board combines the appropriate functions and then routes them to the appropriate subsystem. For instance, a spectrometer is used to collect wavelength resolved optical data. In order to acquire this data, some DIO is required to synchronize the readout. The actual signal itself is an analog signal that is read out by the analog part of the compact RIO. For an included temperature control subsystem the set-point temperature is set by an analog voltage requiring AO from the compactRIO. The temperature readout is likewise an analog voltage requiring AI from the compactRIO.

The reconfigurable chassis together with the graphically programmable controller over specific advantages for label free binding instruments as the instrument development process is considerably simplified by their incorporation.

What is claimed is:

1. A method for building a biosensor instrument using a control computer, wherein the control computer is programmed in a graphical computer language.

2. The method as in claim 1 wherein the biosensor instrument uses a label free binding scheme

3. The method as in claim 1 wherein the graphical programming language is LabView

4. The method as in claim 1 wherein the control computer is embedded in a chassis

5. The method as in claim 4 wherein the chassis is a compactRIO chassis
